(19) United States
(12) Patent Application Publication
(10) Pub. No.: US 2024/0221118 A1
(43) Pub. Date: Jul. 4, 2024

(54) VIDEO CONVERTING APPARATUS

(71) Applicant: Sharp Kabushiki Kaisha, Osaka (JP)

(72) Inventors: Takeshi CHUJOH, Sakai City (JP); Tomohiro IKAI, Sakai City (JP); Eiichi SASAKI, Sakai City (JP); Norio ITOH, Sakai City (JP); Hiroshi WATANABE, Tokyo (JP)

(21) Appl. No.: 18/610,360

(22) Filed: Mar. 20, 2024

Related U.S. Application Data
(63) Continuation of application No. 17/035,799, filed on Sep. 29, 2020.

(30) Foreign Application Priority Data
Oct. 4, 2019 (JP) 2019-183899

(51) Int. Cl. G06T 3/4053; G06T 1/60; G06T 5/50; G06T 9/00

(52) U.S. Cl. CPC G06T 3/4053; G06T 1/60; G06T 5/50; G06T 9/00; G06T 2207/20016

(57) ABSTRACT

A video converting apparatus includes an image buffer unit configured to store multiple images, a super-resolution processing unit configured to perform super-resolution processing on an image input from the image buffer unit to output a super-resolution image, and a prediction image generation unit configured to reference the super-resolution image output by the super-resolution processing unit to generate a prediction image.

### CROSS-REFERENCE TO RELATED APPLICATIONS

This application claims the benefit of priority to Japanese Patent Application Number 2019-183899 filed on Oct. 4, 2019. The entire contents of the above-identified application are hereby incorporated by reference.

### BACKGROUND

### Technical Field

Embodiments of the disclosure relate to a video converting apparatus and a video converting method.

A video coding apparatus which generates coded data by coding a video, and a video decoding apparatus which generates decoded images by decoding the coded data are used for efficient transmission or recording of videos.

Specific video coding schemes include, for example, H.264/AVC, High-Efficiency Video Coding (HEVC), and the like.

On the other hand, advancement of display devices and image capturing devices enables acquisition and display of high-resolution videos. Thus, there is a need for a method for converting the resolution of known low-resolution videos to a high resolution. Additionally, a high-resolution video has an enormous amount of data, and thus a possible method for transmitting or recording a video at a low rate may include temporarily converting the video into a low resolution, coding the low-resolution video, transmitting or recording the coded video, decoding the video, converting the decoded video into a high resolution, and displaying the high-resolution video.

Such a technique is known as a super-resolution technique for converting a low-resolution video to a high resolution. An example of the recent video super-resolution technique is M. Sajjadi, R. Vemulapalli and M. Brown, Frame-Recurrent Video Super-Resolution. IEEE/CVF Conference on Computer Vision and Pattern Recognition (CVPR 2018) (pp. 6626-6634, Piscataway, 2018).

### SUMMARY

However, a method described in M. Sajjadi, R. Vemulapalli and M. Brown, Frame-Recurrent Video Super-Resolution. IEEE/CVF Conference on Computer Vision and Pattern Recognition (CVPR 2018) (pp. 6626-6634, Piscataway, 2018) has room for improvement in processing for generating a prediction image.

An object of the disclosure is to achieve a video converting apparatus that can generate a prediction image with reference to a preferable image subjected to super-resolution processing.

A video converting apparatus according to an aspect of the disclosure includes an image buffer unit configured to store multiple images, a super-resolution processing unit configured to perform super-resolution processing on an image input from the image buffer unit to output a super-resolution image, and a prediction image generation unit configured to reference the super-resolution image output by the super-resolution processing unit to generate a prediction image.

According to an aspect of the disclosure, a video converting apparatus can be achieved that can generate a prediction image with reference to a preferable image subjected to super-resolution processing.

### BRIEF DESCRIPTION OF DRAWINGS

The disclosure will be described with reference to the accompanying drawings, wherein like numbers reference like elements.

FIG. 1 is a schematic diagram illustrating a configuration of an image transmission system according to the present embodiment.

FIG. 2 is a diagram illustrating configurations of a transmitting apparatus equipped with a video coding apparatus and a receiving apparatus equipped with a video decoding apparatus according to the present embodiment. PROD A denotes the transmitting apparatus equipped with the video coding apparatus, and PROD_B denotes the receiving apparatus equipped with the video decoding apparatus.

FIG. 3 is a diagram illustrating configurations of a recording apparatus equipped with the video coding apparatus and a reconstruction apparatus equipped with the video decoding apparatus according to the present embodiment. PROD_C denotes the recording apparatus equipped with the video coding apparatus, and PROD_D denotes the reconstruction apparatus equipped with the video decoding apparatus.

FIG. 4 is a diagram illustrating a hierarchical structure of data in a coding stream.

FIG. 5 is a conceptual diagram illustrating examples of reference pictures and reference picture lists.

FIG. 6 is a schematic diagram illustrating a configuration of the video decoding apparatus.

FIG. 7 is a flowchart illustrating general operations of the video decoding apparatus.

FIG. 8 is a functional block diagram of a video converting apparatus according to an example of the present embodiment.

FIG. 9 is a functional block diagram of a video converting apparatus according to another example of the present embodiment.

FIG. 10 is a conceptual diagram illustrating processing performed by the video converting apparatus according to the present embodiment.

FIG. 11 is a functional block diagram of a video converting apparatus according to an example of the present embodiment.

FIG. 12 is a functional block diagram of a video converting apparatus according to another example of the present embodiment.

FIG. 13 is a functional block diagram of a video converting apparatus according still another example of to the present embodiment.

FIG. 14 is a block diagram illustrating a configuration of the video coding apparatus.

FIG. 15 is a functional block diagram of a coded data generation apparatus according to an example of the present embodiment.

FIG. 16 is a functional block diagram of a coded data generation apparatus according to another example of the present embodiment.

FIG. 17 is a functional block diagram of a video converting apparatus according to the present embodiment.

FIG. 18 is a functional block diagram of a coded data generation apparatus according to the present embodiment.

### DESCRIPTION OF EMBODIMENTS

### Embodiment

Hereinafter, embodiments of the present disclosure will be described with reference to the drawings.

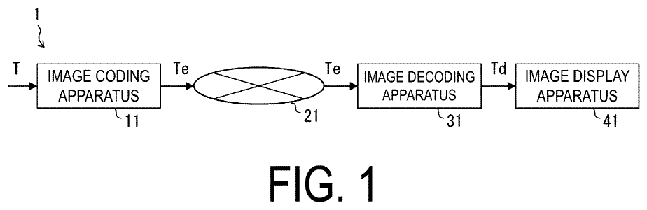

FIG. 1 is a schematic diagram illustrating a configuration of an image transmission system 1 according to the present embodiment.

The image transmission system 1 is a system transmitting a coding stream including a coded target image, decoding the transmitted coding stream, and displaying an image. The image transmission system 1 includes a video coding apparatus (image coding apparatus) 11, a network 21, a video decoding apparatus (image decoding apparatus) 31, and a video display apparatus (video display apparatus) 41.

An image T is input to the video coding apparatus 11.

The network 21 transmits, to the video decoding apparatus 31, a coding stream Te generated by the video coding apparatus 11. The network 21 is the Internet, a Wide Area Network (WAN), a small-scale network (Local Area Network (LAN)), or a combination thereof. The network 21 is not necessarily limited to a bidirectional communication network, and may be a unidirectional communication network configured to transmit broadcast waves of digital terrestrial television broadcasting, satellite broadcasting or the like. Additionally, the network 21 may be substituted by a storage medium in which the coding stream Te is recorded, such as a Digital Versatile Disc (DVD, registered trademark) or a Blue-ray Disc (BD, registered trademark).

The video decoding apparatus 31 decodes each of the coding streams Te transmitted by the network 21 and generates one or multiple decoded images Td.

The video display apparatus 41 displays all or part of the one or multiple decoded images Td generated by the video decoding apparatus 31. For example, the video display apparatus 41 includes a display device such as a liquid crystal display and an organic Electro-luminescence (EL) display. Configurations of the display include a stationary configuration, a mobile configuration, an HMD, and the like. In addition, in a case that the video decoding apparatus 31 has a high processing capability, the display displays images with high image quality, and in a case that the video decoding apparatus 31 only has a lower processing capability, the display displays images which do not require a high processing or display capability.

### Operator

Operators used in the present specification will be described below.

>> is a right bit shift, << is a left bit shift, & is a bitwise AND, | is a bitwise OR, |= is an OR assignment operator, and ∥ indicates a logical sum.

x?y: z is a ternary operator to take y in a case that x is true (other than 0) and to take z in a case that x is false (0).

Clip3 (a, b, c) is a function to clip c in a value equal to or greater than a and less than or equal to b, and a function to return a in a case that c is less than a (c<a), return b in a case that c is greater than b (c>b), and return c in other cases (provided that a is less than or equal to b (a<=b)).

abs (a) is a function that returns the absolute value of a.

Int (a) is a function that returns an integer value of a.

floor (a) is a function that returns a maximum integer equal to or less than a.

ceil (a) is a function that returns a minimum integer equal to or greater than a.

a/d represents the division of a by d (decimals are omitted).

### Structure of Coding Stream Te

Prior to the detailed description of the video coding apparatus 11 and the video decoding apparatus 31 according to the present embodiment, a data structure of the coding stream Te generated by the video coding apparatus 11 and decoded by the video decoding apparatus 31 will be described.

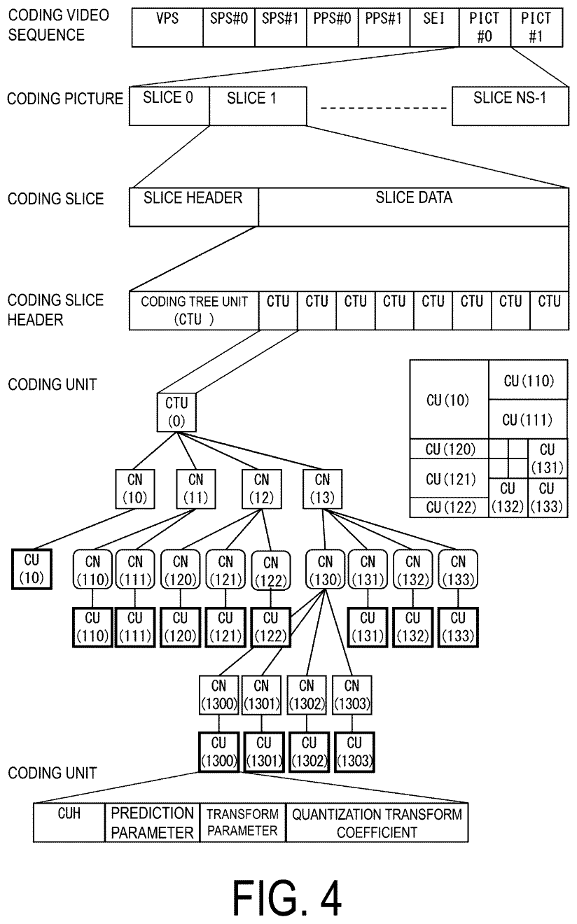

FIG. 4 is a diagram illustrating a hierarchical structure of data in the coding stream Te. The coding stream Te includes a sequence and multiple pictures constituting the sequence illustratively. FIG. 4 illustrates a coding video sequence defining a sequence SEQ, a coding picture defining a picture PICT, a coding slice defining a slice S, a coding slice data defining slice data, a coding tree unit included in the coding slice data, and a coding unit (CU) included in each coding tree unit, respectively.

### Coding Video Sequence

In the coding video sequence, a set of data referenced by the video decoding apparatus 31 to decode the sequence SEQ to be processed is defined. As illustrated in FIG. 4, the sequence SEQ includes a Video Parameter Set, a Sequence Parameter Set SPS, a Picture Parameter Set PPS, Adaptation Parameter Set (APS), a picture PICT, and Supplemental Enhancement Information SEI.

In the video parameter set VPS, in a video including multiple layers, a set of coding parameters common to multiple videos and a set of coding parameters associated with the multiple layers and an individual layer included in the video are defined.

In the sequence parameter set SPS, a set of coding parameters referenced by the video decoding apparatus 31 to decode a target sequence is defined. For example, a width and a height of a picture are defined. Note that multiple SPSs may exist. In that case, any of multiple SPSs is selected from the PPS.

In the picture parameter set PPS, a set of coding parameters referenced by the video decoding apparatus 31 to decode each picture in a target sequence is defined. For example, a reference value (pic_init_qp_minus26) of a quantization step size used for decoding of a picture and a flag (weighted_pred_flag) indicating an application of a weighted prediction are included. Note that multiple PPSs may exist. In that case, any of multiple PPSs is selected from each picture in a target sequence.

### Coding Picture

In the coding picture, a set of data referenced by the video decoding apparatus 31 to decode the picture PICT to be processed is defined. As illustrated in FIG. 4, the picture PICT includes slices 0 to NS−1 (NS is the total number of slices included in the picture PICT).

Note that in a case that it is not necessary to distinguish the slices 0 to NS−1 from one another, indexes of reference signs may be omitted. In addition, the same applies to other data with subscripts included in the coding stream Te which will be described below.

### Coding Slice

In the coding slice, a set of data referenced by the video decoding apparatus 31 to decode the slice S to be processed is defined. As illustrated in FIG. 4, the slice includes a slice header and slice data.

The slice header includes a coding parameter group referenced by the video decoding apparatus 31 to determine a decoding method for a target slice. Slice type specification information (slice_type) indicating a slice type is one example of a coding parameter included in the slice header.

Examples of slice types that can be specified by the slice type specification information include (1) I slice using only an intra prediction in coding, (2) P slice using a unidirectional prediction or an intra prediction in coding, and (3) B slice using a unidirectional prediction, a bidirectional prediction, or an intra prediction in coding, and the like. Note that the inter prediction is not limited to a uni-prediction or a bi-prediction, and a greater number of reference pictures may be used to generate the prediction image. Hereinafter, the designations P and B slices refer to slices including blocks for which inter prediction can be used.

Note that, the slice header may include a reference to the picture parameter set PPS (pic_parameter_set_id).

### Coding Slice Data

In the coding slice data, a set of data referenced by the video decoding apparatus 31 to decode the slice data to be processed is defined. The slice data includes a CTU, as illustrated in the coding slice header in FIG. 4. A CTU is a block of a fixed size (for example, 64×64) constituting a slice, and may be referred to as a Largest Coding Unit (LCU).

### Coding Tree Unit

In FIG. 4, a set of data referenced by the video decoding apparatus 31 to decode the CTU to be processed is defined. The CTU is split into coding units CU corresponding to basic units of coding processing, by recursive Quad Tree (QT) split, Binary Tree (BT) split, or Ternary Tree (TT) split. The BT split and the TT split are collectively referred to as Multi Tree split (MT split). Nodes of a tree structure obtained by recursive quad tree split are referred to as Coding Nodes (CNs). Intermediate nodes of the quad tree, the binary tree, and the ternary tree are coding nodes, and the CTU itself is also defined as the highest coding node.

The CT includes, as CT information, a CU split flag (split_cu_flag) indicating whether to perform the CT split or not, a QT split flag (qt_split_cu_flag) indicating whether to perform the QT split or not, an MT split direction (mtt_split_cu_vertical_flag) indicating the split direction of the MT split, and an MT split type (mtt_split_cu_binary_flag) indicating the split type of the MT split. split_cu_flag, qt_split_cu_flag, mtt_split_cu_vertical_flag, and mtt_split_cu_binary_flag are transmitted for each coding node.

For example, in a case that the size of the CTU is 64×64 pixels, the CU may have a size of one of 64×64 pixels, 64×32 pixels, 32×64 pixels, 32×32 pixels, 64×16 pixels, 16×64 pixels, 32×16 pixels, 16×32 pixels, 16×16 pixels, 64×8 pixels, 8×64 pixels, 32×8 pixels, 8×32 pixels, 16×8 pixels, 8×16 pixels, 8×8 pixels, 64×4 pixels, 4×64 pixels, 32×4 pixels, 4×32 pixels, 16×4 pixels, 4×16 pixels, 8×4 pixels, 4×8 pixels, and 4×4 pixels.

Different trees may be used for luminance and for chrominance. The type of tree is indicated by treeType. For example, in a case that a common tree is used for luminance (Y, cIdx=0) and chrominance (Cb/Cr, cIdx=1, 2), a common single tree is indicated by treeType=SINGLE_TREE. In a case that two different trees (DUAL tree) are used for luminance and for chrominance, the tree for luminance is indicated by treeType=DUAL_TREE_LUMA, and the tree for chrominance is indicated by treeType=DUAL_TREE_CHROMA.

### Coding Unit

In FIG. 4, a set of data referenced by the video decoding apparatus 31 to decode the coding unit to be processed is defined. Specifically, the CU includes a CU header CUH, a prediction parameter, a transform parameter, a quantization transform coefficient, and the like. In the CU header, a prediction mode and the like are defined.

The prediction processing may be performed on a per CU basis or on a per sub-CU basis, the sub-CU being obtained by further splitting the CU. In a case that the CU is equal in size to the sub-CU, the CU contains one sub-CU. In a case that the CU is larger in size than the sub-CU, the CU is split into sub-CUs. For example, in a case that the CU has a size of 8×8 and that the sub-CU has a size of 4×4, the CU is split into four sub-CUs which include two horizontal sub-CUs and two vertical sub-CUs.

Two types of predictions (prediction modes) are available: intra prediction and inter prediction. The intra prediction refers to a prediction within an identical picture, and the inter prediction refers to prediction processing performed between different pictures (for example, between pictures of different display times, and between pictures of different layer images).

Conversion and quantization processing is performed on a per CU basis, but the quantization transform coefficient may be entropy coded in sub-block units such as 4×4.

### Prediction Parameter

The prediction image is derived based on a prediction parameter associated with the block. The prediction parameter includes a prediction parameter of intra prediction or a prediction parameter of inter prediction.

The prediction parameter of inter prediction will be described below. The inter prediction parameter includes a prediction list utilization flags predFlagL0 and predFlagL1, reference picture indexes refIdxL0 and refIdxL1, and motion vectors mvL0 and mvL1. predFlagL0 and predFlagL1 are flags each indicating whether a reference picture list (L0 list or L1 list) is used or not, and the value of 1 causes the corresponding reference picture list to be used. Note that, in a case that the present specification mentions “a flag indicating whether or not XX”, a flag being other than 0 (for example, 1) assumes a case of XX, and a flag being 0 assumes a case of not XX, and 1 is treated as true and 0 is treated as false in a logical negation, a logical product, and the like (hereinafter, the same is applied). However, other values can be used for true values and false values in real apparatuses and methods.

For example, syntax elements to derive inter prediction parameters include, for example, an affine flag affine flag, a merge flag merge_flag, a merge index merge_idx, and an MMVD flag mmvd_flag used in a merge mode, an inter prediction indicator inter_pred_idc and a reference picture index refIdxLX for selecting a reference picture used in an AMVP mode, and a prediction vector index mvp_LX_idx, a difference vector mvdLX, and a motion vector accuracy mode amvr_mode for deriving a motion vector.

### Reference Picture List

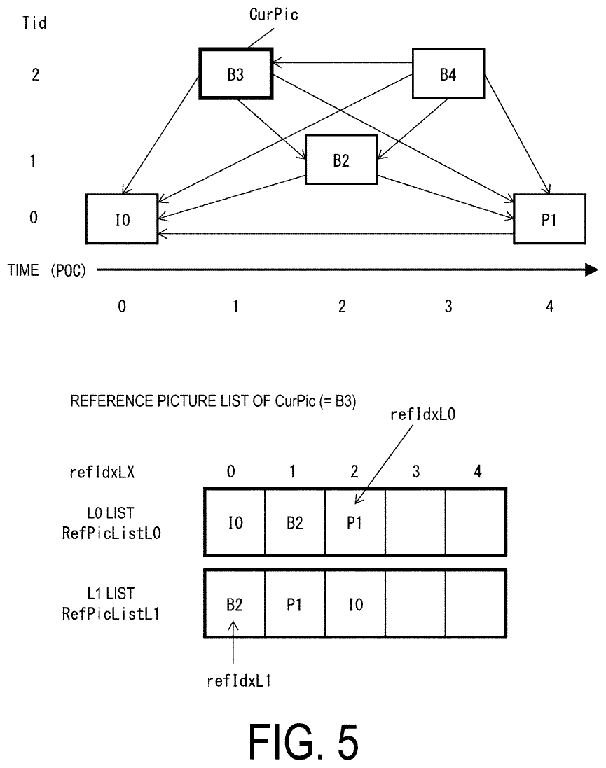

A reference picture list is a list constituted by reference pictures stored in a reference picture memory 306. FIG. 5 is a conceptual diagram illustrating examples of reference pictures and reference picture lists. In the conceptual diagram in FIG. 5, illustrating examples of reference pictures, rectangles indicate pictures, arrows indicate reference relations among the pictures, a horizontal axis indicates time, I, P, and B in the rectangles indicate an intra picture, a uni-prediction picture, a bi-prediction picture, and numbers in the rectangles indicate the order of decoding. As illustrated, the decoding order of the pictures is I0, P1, B2, B3, and B4, and the display order is I0, B3, B2, B4, and P1. FIG. 5 illustrates an example of a reference picture list of a picture B3 (target picture). The reference picture list is a list to represent a candidate of a reference picture, and one picture (slice) may include one or more reference picture lists. In the illustrated example, a target picture B3 includes two reference picture lists, i.e., a L0 list RefPicList0 and a L1 list RefPicList1. In the individual CUs, refIdxLX indicates which of the pictures in the reference picture list RefPicListX (X=0 or 1) is actually referenced. The figure illustrates an example of refIdxL0=2 and refIdxL1=0. Note that LX is a description method used in a case that the L0 prediction and the L1 prediction are not distinguished from each other, and parameters for the L0 list are distinguished from parameters for the L1 list by replacing LX with L0 and L1.

inter_pred_idc is a value indicating types and the number of reference pictures, and takes one of the values PRED_L0, PRED_L1, and PRED_B1. PRED_L0 and PRED_L1 each indicate a uni-prediction using one reference picture respectively managed in the L0 list or the L1 list. PRED_B1 indicates a bi-prediction using two reference pictures managed in the L0 list and the L1 list.

### Motion Vector

mvLX indicates the amount of shift between blocks between two different pictures. A prediction vector and a difference vector related to mvLX are respectively referred to as mvpLX and mvdLX.

### Configuration of Video Decoding Apparatus

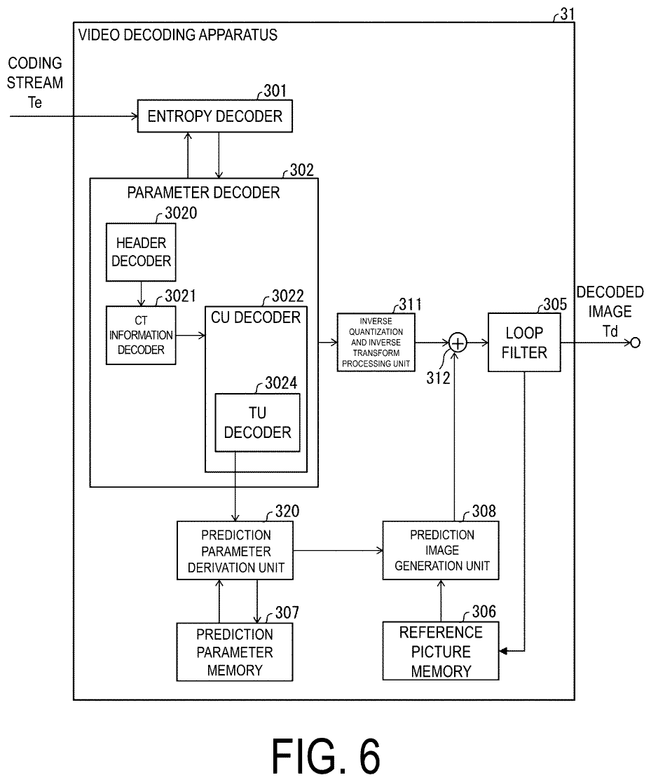

Now, a configuration of the video decoding apparatus 31 according to the present embodiment (FIG. 6) will be described.

The video decoding apparatus 31 includes an entropy decoder 301, a parameter decoder (a prediction image decoding apparatus) 302, a loop filter 305, a reference picture memory 306, a prediction parameter memory 307, a prediction image generation unit (prediction image generation apparatus) 308, an inverse quantization and inverse transform processing unit 311, an addition unit 312, and a prediction parameter derivation unit 320. Note that, depending on the configuration, the video decoding apparatus 31 does not include the loop filter 305 in accordance with the video coding apparatus 11 described below.

The parameter decoder 302 further includes a header decoder 3020, a CT information decoder 3021, and a CU decoder 3022 (prediction mode decoder). The CU decoder 3022 further includes a TU decoder 3024. These may be collectively referred to as decoding modules. The header decoder 3020 decodes parameter set information such as VPS, SPS, PPS, APS, the slice header (slice information) from the coded data. The CT information decoder 3021 decodes the CT from the coded data. The CU decoder 3022 decodes the CU from the coded data. In a case that the TU includes a prediction error, the TU decoder 3024 decodes QP update information (quantization correction value) and a quantization prediction error (residual_coding) from the coded data.

The TU decoder 3024 decodes the QP update information and the quantization prediction error from the coded data in the mode other than the skip mode (skip_mode==0). More specifically, in a case of skip_mode==0, the TU decoder 3024 decodes a flag cu_cbp indicating whether a quantization prediction error is included in the target block, and in a case of cu_cbp being 1, decodes the quantization prediction error. In a case that cu_cbp is not present in the coded data, 0 is derived.

The TU decoder 3024 decodes an index mts_idx indicating a transform basis from the coded data. Additionally, the TU decoder 3024 decodes an index stIdx indicating use of a secondary conversion and a transform basis from the coded data. stIdx being 0 indicates non-application of the secondary conversion, stIdx being 1 indicates one transform of a set (pair) of secondary transform bases, and stIdx being 2 indicates the other transform of the pair.

Additionally, the TU decoder 3024 may decode a sub-block transform flag cu_sbt_flag. In a case that cu_sbt_flag is 1, the CU is split into multiple sub-blocks, and for only one particular sub-block, the residual is decoded. Furthermore, the TU decoder 3024 may decode a flag cu_sbt_quad_flag indicating whether the number of sub-blocks is 4 or 2, cu_sbt_horizontal_flag indicating a split direction, and cu_sbt_pos_flag indicating a sub-block including a non-zero transform coefficient.

The prediction image generation unit 308 includes an inter prediction image generation unit 309 and an intra prediction image generation unit 310.

The prediction parameter derivation unit 320 includes an inter prediction parameter derivation unit 303 and an intra prediction parameter derivation unit 304.

Additionally, in the example described below, CTUs and CUs are used as units of processing, but the disclosure is not limited to this example, and the processing may be performed on a per sub-CU basis. Alternatively, the CTUs and CUs may be interpreted as blocks, the sub-CUs may be interpreted as sub-blocks, and the processing may be performed on a per block or sub-block basis.

The entropy decoder 301 performs entropy decoding on the coding stream Te input from the outside and separates to decode individual codes (syntax elements). Entropy coding includes a scheme for variable-length-coding syntax elements using context (probability model) adaptively selected depending on the type of the syntax element or the surrounding situation, and a scheme for variable-length-coding syntax elements using a predetermined table or calculation formula. The former scheme Context Adaptive Binary Arithmetic Coding (CABAC) stores in memory the CABAC state of the context (the type of a dominant symbol (0 or 1) and a probability state index pStateIdx indicating a probability). The entropy decoder 301 initializes all CABAC states at the beginning of each segment (tile, CTU row, or slice). The entropy decoder 301 converts the syntax element into a binary string (Bin String) and decodes each bit of the Bin String. In a case where a context is used, a context index ctxInc is derived for each bit of the syntax element, the bit is decoded using the context, and the CABAC state of the context used is updated. Bits that do not use context are decoded at an equal probability (EP or bypass), with ctxInc derivation and the CABAC state omitted. The decoded syntax elements include prediction information used to generate a prediction image, a prediction error used to generate a difference image, and the like.

The entropy decoder 301 outputs, to the parameter decoder 302, codes resulting from decoding. The codes resulting from decoding include, for example, a prediction mode predMode, merge_flag, merge_idx, inter_pred_idc, refIdxLX, mvp_LX_idx, mvdLX, amvr_mode, and the like. Which code is to be decoded is controlled based on an indication from the parameter decoder 302.

### Basic Flow

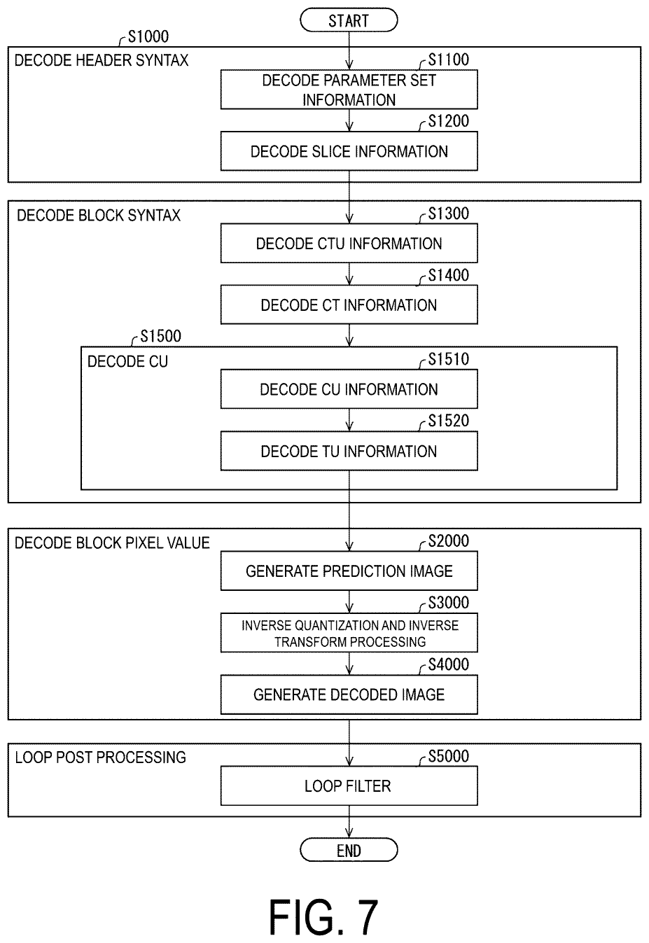

FIG. 7 is a flow chart illustrating a schematic operation of a video decoding apparatus 31.

(S1100: Decode parameter set information) The header decoder 3020 decodes parameter set information such as VPS, SPS, and PPS from the coded data.

(S1200: Decode slice information) The header decoder 3020 decodes the slice header (slice information) from the coded data.

Subsequently, the video decoding apparatus 31 repeats processing from S1300 to S5000 for each CTU included in the target picture to derive a decoded image of each CTU.

(S1300: Decode CTU information) the CT information decoder 3021 decodes the CTU from the coded data.

(S1400: Decode CT information) the CT information decoder 3021 decodes the CT from the coded data.

(S1500: Decode CU) the CU decoder 3022 performs S1510 and S1520 to decode the CU from the coded data.

(S1510: Decode CU information) the CU decoder 3022 decodes, from the coded data, CU information, prediction information, a TU split flag split_transform_flag, a CU residual flag cbf_cb, cbf_cr, cbf_luma, and the like.

(S1520: Decode TU information) the TU decoder 3024 decodes the QP update information, the quantization prediction error, and the transform index mts_idx from the coded data in a case that the TU includes a prediction error. Note that the QP update information is a value indicating a difference from a quantization parameter prediction value qPpred, which is a prediction value of a quantization parameter QP.

(S2000: Generate prediction image) The prediction image generation unit 308 generates the prediction image based on the prediction information for each block included in the target CU.

(S3000: Inverse quantization and inverse transform processing) the inverse quantization and inverse transform processing unit 311 performs inverse quantization and inverse transform processing on each of the TUs included in the target CU.

(S4000: Generate decoded image) the addition unit 312 generates a decoded image of the target CU by adding the prediction image fed by the prediction image generation unit 308 and the prediction error fed by the inverse quantization and inverse transform processing unit 311.

(S5000: Loop filter) the loop filter 305 applies a loop filter such as a deblocking filter, SAO, ALF, or the like to the decoded image to generate a decoded image.

The loop filter 305 is a filter provided in a coding loop to remove block distortion and ringing distortion, improving image quality. The loop filter 305 applies a filter such as a deblocking filter, a Sample Adaptive Offset (SAO), and an Adaptive Loop Filter (ALF) on a decoded image of a CU generated by the addition unit 312.

The reference picture memory 306 stores a decoded image of the CU at a predetermined position for each picture and CU to be decoded.

The prediction parameter memory 307 stores the prediction parameter at a predetermined position for each CTU or CU. Specifically, the prediction parameter memory 307 stores parameters decoded by the parameter decoder 302, parameters derived by the prediction parameter derivation unit 320, and the like.

The parameter derived by the prediction parameter derivation unit 320 is input to the prediction image generation unit 308. In addition, the prediction image generation unit 308 reads a reference picture from the reference picture memory 306. The prediction image generation unit 308 generates a prediction image of the block or the subblock by using the parameter and the reference picture (reference picture block) in the prediction mode indicated by predMode. Here, the reference picture block refers to a set of pixels (referred to as a block because the set is normally rectangular) on the reference picture and is a region referenced to generate a prediction image.

The inverse quantization and inverse transform processing unit 311 performs inverse quantization on a quantization transform coefficient input from the parameter decoder 302 to calculate a transform coefficient.

The inverse quantization and inverse transform processing unit 311 includes a scaling unit (inverse quantization unit), a secondary converting unit, and a core transform converting unit.

The scaling unit derives a scaling factor ls[x][y] using a quantization matrix m[x][y] or a uniform matrix m[x][y]=16 decoded from the coded data, a quantization parameter qP, and rectNonTsFlag derived from the TU size.

$$ls [ x ] [ y ] = ( m [ x ] [ y ] * levelScale [ rectNonTsFlag ] [ qP \% 6 ] ) << ( qP / 6 )$$

Here, levelScale [ ]={{40, 45, 51, 57, 64, 72}, {57, 64, 72, 81, 91, 102}}.

$$rectNonTsFlag = ( ( ( Log 2 ( nTbW ) + Log 2 ( nTbH ) ) \& 1 ) == 1 \&\& transform\_skip \_flag == 0 )$$

A scaling unit 31112 derives dnc[ ][ ] from the product of ls[ ][ ] and the transform coefficient TransCoeffLevel, and performs inverse quantization on dnc[ ][ ]. Furthermore, d[ ][ ] is derived by clipping.

$$dnc [ x ] [ y ] = ( TransCoeffLevel [ xTbY ] [ yTbY ] [ cIdx ] [ x ] [ y ] * ls [ x ] [ y ] + bdOffset ) >> bdShift$$

$$d [ x ] [ y ] = Clip 3 ( CoeffMin , CoeffMax , dnc [ x ] [ y ] )$$

$$bdShift = bitDepth + ( ( rectNonTsFlag ? 1 : 0 ) + ( Log 2 ( nTbW ) + Log 2 ( nTbH ) ) / 2 ) - 5 + dep\_quant \_enabled \_flag$$

$$bdOffset = ( 1 << bdShift ) >> 1$$

The secondary converting unit applies a conversion using a transformation matrix to some or all of the transform coefficients d[ ][ ] received from the scaling unit to reconstruct modified transform coefficients (transform coefficients resulting from the conversion by the second converting unit) d[ ][ ]. The secondary converting unit applies a secondary conversion to transform coefficients d[ ][ ] in a prescribed unit for each TU. The secondary conversion is applied only in intra CUs, and the transform basis is determined with reference to stIdx and IntraPredMode. The secondary converting unit outputs the reconstructed modification transform coefficient d[ ][ ] to a core converting unit.

The core converting unit converts the transform coefficient d[ ][ ] or the modified transform coefficient d[ ][ ] by using the selected transformation matrix, and derives a prediction error r[ ][ ]. The core converting unit outputs the prediction error r[ ][ ] (resSamples[ ][ ]) to the addition unit 312. Note that the inverse quantization and inverse transform processing unit 311 sets a prediction error in the target block to all zero in a case that skip_flag is 1 or cu_cbp is 0. The transformation matrix may be selected from multiple transform matrices based on mts_idx.

The prediction error d[ ][ ] resulting from the core conversion may further be shifted to achieve the same accuracy as that of the prediction image Pred[ ][ ] to derive resSamples[ ][ ].

$$resSamples [ x ] [ y ] = ( r [ x ] [ y ] + ( 1 << ( bdShift - 1 ) ) ) >> bdShift$$

$$bdShift = Max ( 20 - bitDepth , 0 )$$

The addition unit 312 adds the prediction image of the block input from the prediction image generation unit 308 to the prediction error input from the inverse quantization and inverse transform processing unit 311 for each pixel to generate a decoded image of the block. The addition unit 312 stores the decoded image of the block in the reference picture memory 306 and outputs the decoded image to the loop filter 305.

### Configuration Example 1 of Video Converting Apparatus

The video converting apparatus according to the present embodiment will be described below. The video converting apparatus according to the present embodiment is an apparatus increasing the resolution of an image (picture or video) and outputting the resultant image.

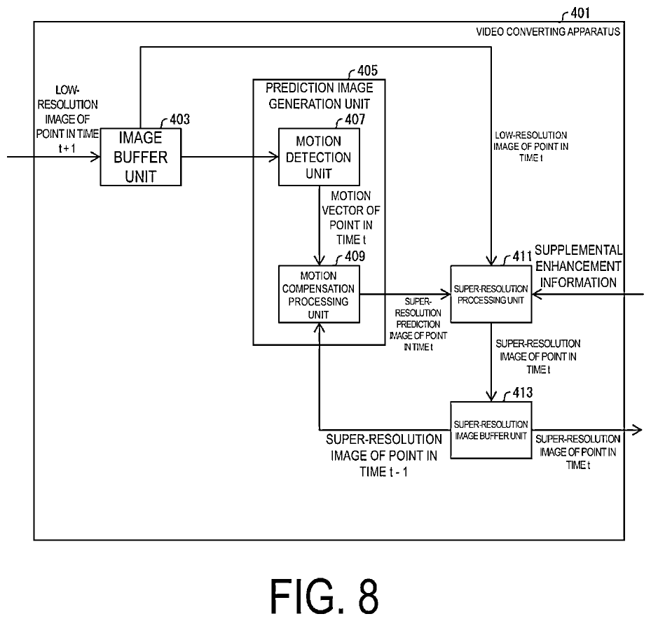

FIG. 8 is a functional block diagram of a video converting apparatus 401 according to the present example. As illustrated in FIG. 8, the video converting apparatus 401 according to the present example includes an image buffer unit 403, a prediction image generation unit 405, a super-resolution processing unit 411, and a super-resolution image buffer unit 413.

The image buffer unit 403 stores multiple low-resolution images. The prediction image generation unit 405 includes a motion detection unit 407 and a motion compensation processing unit 409.

The motion detection unit 407 references the low-resolution image input from the image buffer unit 403 to derive a motion vector of a certain point in time t. For example, the image buffer unit 403 may store images corresponding to three frames (three pictures) of points in time t−1, t, and t+1, and the motion detection unit 407 may reference the images corresponding to the points in time t−1 and t+1 to derive a motion vector of the point in time t.

Here, the point in time t−1 indicates a past point in time a unit time before the point in time t, the unit time corresponding to one frame (one picture) of the image signal, and the point in time t+1 described below indicates a future point in time the unit time after the point in time t. Additionally, the super-resolution prediction image is a prediction image subjected to super-resolution processing or an image corresponding to the prediction image.

The motion compensation processing unit 409 references the motion vector at the point in time t input from the motion detection unit 407 and the super-resolution image of the point in time t−1 input from the super-resolution image buffer unit 413 to generate a super-resolution prediction image of the point in time t, with, and outputs the generated image to the super-resolution processing unit 411.

The super-resolution processing unit 411 references the super-resolution prediction image of the point in time t input from the motion compensation processing unit 409 to perform super-resolution processing on the image of the point in time t input from the image buffer unit 403, and outputs the super-resolution image of the point in time t. In other words, the super-resolution processing unit 411 references the image of the point in time t input from the image buffer unit 403 and the above-described super-resolution prediction image, and outputs the above-described super-resolution image.

Note that, as illustrated in FIG. 8, the super-resolution processing unit 411 may appropriately reference supplemental enhancement information in a case of performing super-resolution processing. Additionally, the super-resolution processing unit 411 may be learned using a Convolutional Neural Network (CNN), a Generative Adversarial Network (GAN), or the like.

Here, the supplemental enhancement information is information that may be referenced by one of the image buffer unit 403, the super-resolution processing unit 411, and the prediction image generation unit 405, and is information specifying processing performed at the reference source.

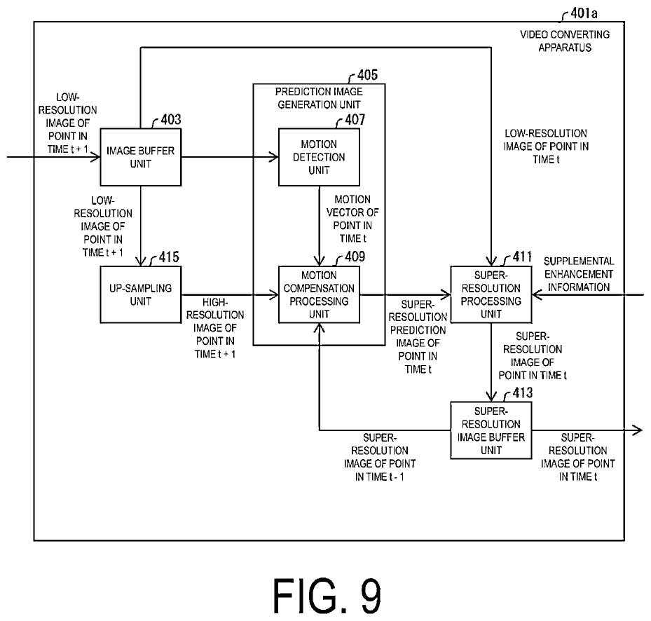

The image buffer unit 403 may determine the order of the stored images with reference to the supplemental enhancement information, for example, as described below. Additionally, the super-resolution processing unit 411 may determine, for example, the resolution of the image resulting from the super-resolution processing with reference to the supplemental enhancement information. The prediction image generation unit 405 may reference the supplemental enhancement information to determine whether to generate a prediction image or not. Note that the case where the use of the prediction image is to be avoided is the case in which, in a series of images indicated by image signals, the scene changes suddenly, with no similarity between the preceding and succeeding images or the like. Note that FIG. 8, FIG. 9 described below, and the like illustrate aspects in which the super-resolution processing unit 411 references the supplemental enhancement information.

For example, the supplemental enhancement information includes, as information useful for the super-resolution processing unit 411 to improve image quality, parameters for super-resolution processing in units of target pictures or in units of blocks into which the target picture is split. In a case that an image (original high-resolution image) is available that corresponds to a low-resolution image to be subjected to super-resolution processing, which has not been reduced yet, parameters for super-resolution processing can be selected to provide an image as close as possible to the high-resolution image in accordance with a signal processing criterion such as a square error. For the criterion for providing an image as close as possible to the high-resolution image, a subjective element may be used, for example, a criterion allowing edges to be highlighted. Alternatively, by determining the difference between the image not coded yet and the image coded or decoded, the parameters for super-resolution processing can be generated so as to reconstruct information lost by the coding. By using such parameters for super-resolution processing as supplemental enhancement information, the super-resolution processing unit 411 can improve the image quality. Additionally, in a case that an original image is available that corresponds to a low-resolution image not coded yet and an image coded or decoded is available, then by using, as supplemental enhancement information, parameters taking into account both an error due to coding and an error between an original, high-resolution image and a low-resolution image to be subjected to super-resolution processing, which has not been reduced yet, the image quality can be improved even with the coding processing.

Note that the supplemental enhancement information may be input to the video converting apparatus 401 separately from the image signal, or may be included in a part of the image signal.

The super-resolution image buffer unit 413 stores multiple super-resolution images input from the super-resolution processing unit 411. In addition, of the multiple super-resolution images stored in the super-resolution image buffer unit 413, the super-resolution image of the point in time t−1 is input to the motion compensation processing unit 409. The super-resolution image of the point in time t, which is an output from the super-resolution processing unit 411, is also an output from the video converting apparatus 401, and is, for example, a target for playback.

As described above, the video converting apparatus 401 according to the present example includes the image buffer unit 403 storing multiple images, the prediction image generation unit 405 referencing a super-resolution image stored in the super-resolution image buffer unit 413 to generate a prediction image from an image input from the image buffer unit 403, and the super-resolution processing unit 411 referencing the prediction image to perform super-resolution processing on the image input from the image buffer unit 403. According to the above-described configuration, the video converting apparatus 401 can be achieved that can generate a prediction image with reference a preferable image subjected to super-resolution processing.

Additionally, the video converting method executed by the video converting apparatus 401 according to the present example includes a buffering step for storing multiple images, a prediction image generation step for referencing a super-resolution image stored in the super-resolution image buffer unit 413 to generate a prediction image from the images stored in the buffering step, and a super-resolution processing step for referencing the prediction image to perform super-resolution processing on the image input from the image buffer unit 403. According to the above-described method, a prediction image can be generated with reference to a preferable image subjected to super-resolution processing.

### Configuration Example 2 of Video Converting Apparatus

A second configuration example of a video converting apparatus will be described. In the present example, a configuration will be described in which, in a case of generating a super-resolution prediction image, the prediction image generation unit 405 further references an image. Note that for convenience of description, duplicate description of the above-described matters is not repeated. The same applies to the following examples.

FIG. 9 is a functional block diagram of a video converting apparatus 401a according to the present example. As illustrated in FIG. 9, the video converting apparatus 401a is configured to further include an up-sampling unit 415 in addition to the configuration illustrated in FIG. 8.

The up-sampling unit 415 up-samples an input image to output an image at a higher resolution than the input image on which the up-sampling has not been performed. In the configuration illustrated in FIG. 9, the up-sampling unit 415 up-samples a low-resolution image of the point in time t+1 input from the image buffer unit 403, and outputs the up-sampled image to the motion compensation processing unit 409.

This indicates that the motion compensation processing unit 409 according to the present example further references the up-sampled image of the point in time t+1 in addition to the motion vector of the point in time t and the super-resolution image of the point in time t−1, to generate a super-resolution prediction image of the point in time t.

In this way, even in a case that an occlusion problem occurs with one of the super-resolution image of the point in time t−1 and the up-sampled image of the point in time t+1, the motion compensation processing unit 409 can reference the other image to generate a preferable super-resolution prediction image.

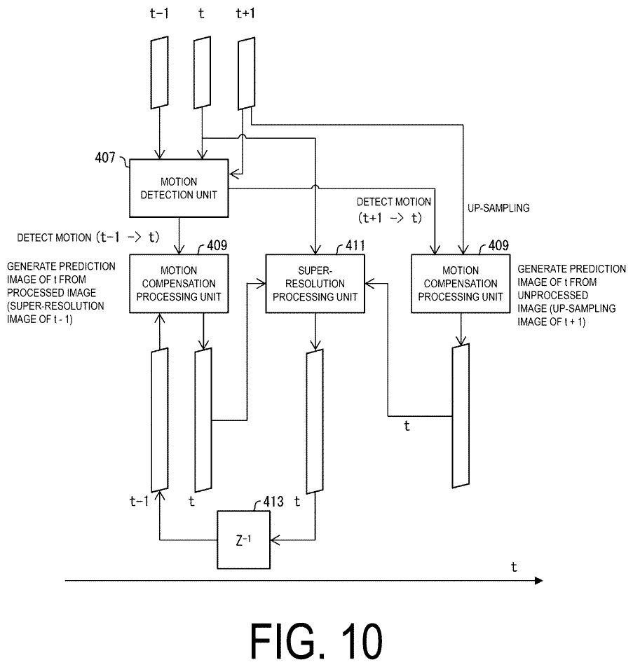

FIG. 10 is a conceptual diagram illustrating processing by the video converting apparatus 401a according to the present example. FIG. 10 illustrates processing in which low-resolution images of the points in time t−1, t, and t+1 are input to the motion detection unit 407 in order, and the motion compensation processing unit 409 references a motion vector of the point in time t, a super-resolution image of the point in time t−1, and an up-sampled image of the point in time t+1 to generate and output a super-resolution image of the point in time t to the super-resolution processing unit 411.

As described above, the video converting apparatus 401a according to the present example further includes an up-sampling unit 415 up-sampling an image input from the image buffer unit 403 to output an image at a higher resolution than the input image on which the up-sampling has not been performed, with respect to the configuration illustrated in FIG. 8, and the prediction image generation unit 405 is configured to reference the super-resolution image of the point in time t−1 and the up-sampled image of the point in time t+1 to generate a prediction image. The above-described configuration can improve the processing performance of generating the super-resolution prediction image.

### Configuration Example 3 of Video Converting Apparatus

A third configuration example of the video converting apparatus will be described. In the present example, a configuration will be described in which the video converting apparatus changes the order of images stored in the image buffer unit 403.

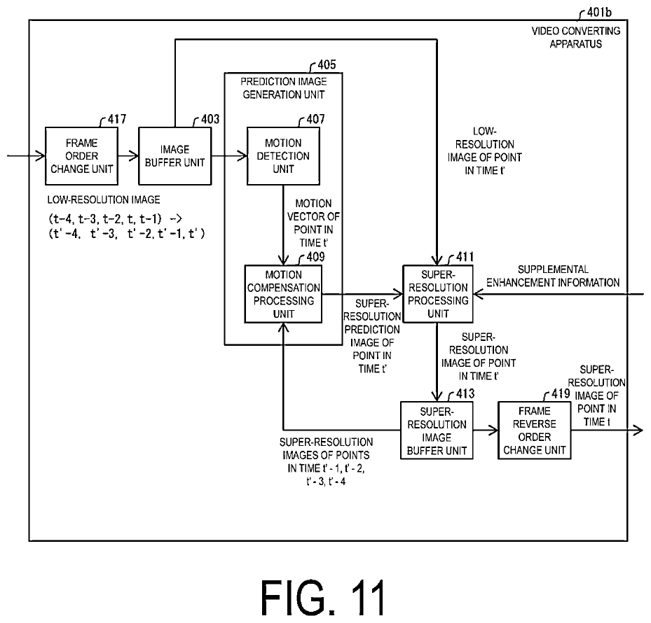

FIG. 11 is a functional block diagram of a video converting apparatus 401b according to the present example. As illustrated in FIG. 11, the video converting apparatus 401b includes, in addition to the configuration illustrated in FIG. 8, a frame order change unit (first order change unit) 417 and a frame reverse order change unit (second frame order change unit) 419.

The frame order change unit 417 changes the chronological order of a low-resolution image to a prescribed order. In the configuration illustrated in FIG. 11, the frame order change unit 417 changes the order of multiple images stored in the image buffer unit 403 to a prescribed order. Specifically, as illustrated in FIG. 11, for example, the frame order change unit 417 chronologically replaces the image of the point in time t with the image of the point in time t−1. Thus, the order of the images to be processed is changed as follows:

$$( t - 4 , t - 3 , t - 2 , t , t - 1 ) = ( t ' = 4 , t ' - 3 , t ' - 2 , t ' - 1 , t ' ) .$$

Note that the order of the images changed by the frame order change unit 417 may be defined by the supplemental enhancement information. In other words, the frame order change unit 417 may change the chronological order of the images in accordance with the content indicated by the supplemental enhancement information.

The frame reverse order change unit 419 changes the chronological order of the images indicated by the image signal to the original order used before the frame order change unit 417 changes the order. In the configuration illustrated in FIG. 11, the frame reverse order change unit 419 changes the order of the super-resolution images input from the super-resolution image buffer unit 413 to the original order.

In the example illustrated in FIG. 11, the motion detection unit 407 according to the present example may derive a motion vector of the point in time t′ with reference to images corresponding to the points in time t′−4, t′−3, t′−2, and t′−1, which correspond to past four frames following the order change.

Additionally, in a case of generating a super-resolution prediction image at the point in time t′, the motion compensation processing unit 409 according to the present example is configured to reference a motion vector of the point in time t′ and super-resolution images of the points in time t′−4, t′−3, t′−2, and t′−1. Thus, the processing performance of generating a super-resolution prediction image can be improved.

For a supplemental description, because the chronological order of the images is changed by the frame order change unit 417, in a case that the motion compensation unit generates a super-resolution prediction image of the point in time t′ (=point in time t−1), a super-resolution image of the point in time t′−1 (=point in time t) after the point in time t′ may also be referenced. Accordingly, even in a case that an occlusion problem occurs with one of an image of a point in time before the point in time t′ and an image of a point in time after the point in time t′, a preferable super-resolution prediction image can be generated with reference to the other image. In addition, a delay acceptable for the images input to the image buffer unit 403 is larger in the configuration of the present example than in the video converting apparatus 401a of the “Configuration Example 2 of Video Converting Apparatus”.

As described above, the video converting apparatus 401b according to the present example includes the frame order change unit 417 changing, to a prescribed order, the order of multiple images stored in the image buffer unit 403 and input to the super-resolution processing unit 411, and the frame reverse order change unit 419 changing the order of super-resolution images output by the super-resolution processing unit 411 to the order used before the frame order change unit 417 changes the order, in addition to the configuration illustrated in FIG. 8. The above-described configuration is effective for facilitating avoidance of an occlusion problem in a case that a prediction image is generated, for example.

### Configuration Example 4 of Video Converting Apparatus

A fourth configuration example of the video converting apparatus will be described. In the present example, a configuration will be described in which an image decoded by the decoding apparatus is input to the image buffer unit 403.

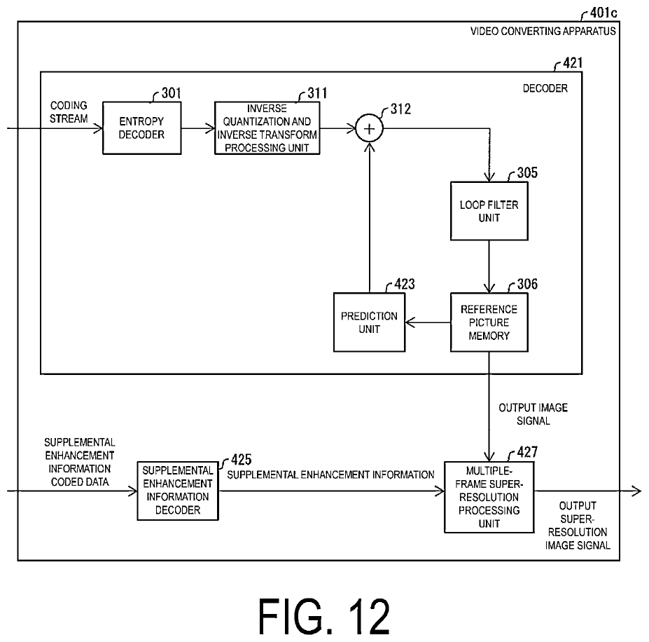

FIG. 12 is a functional block diagram of a video converting apparatus 401c according to the present example. As illustrated in FIG. 12, the video converting apparatus 401c according to the present example includes a decoder (decoding apparatus) 421, a supplemental enhancement information decoder 425, and a multiple-frame super-resolution processing unit 427.

The decoder 421 is a decoding apparatus having functions equivalent to the functions of the video decoding apparatus 31. However, in the example of FIG. 12, the configuration is simplified, and decoded images are output from the reference picture memory 306 to the outside of the decoder 421. The prediction unit 423 performs processing on generation of prediction images.

The supplemental enhancement information decoder 425 decodes coded supplemental enhancement information. In another aspect, the coded supplemental enhancement information may be decoded by the decoder 421 and the supplemental enhancement information coded data may be included in the coding stream.

Additionally, the supplemental enhancement information may be information specifying the processing performed at the reference source, and may be information referenced by any of the image buffer unit 403, the super-resolution processing unit 411, and the prediction image generation unit 405 included in the multiple-frame super-resolution processing unit 427.

The multiple-frame super-resolution processing unit 427 corresponds to a simplified illustration of the video converting apparatus 401 (or 401a or 401b) illustrated in FIG. 8 (or FIG. 9 or FIG. 11), has functions equivalent to the functions of the video converting apparatus 401 and the like, and includes the image buffer unit 403 and the like.

In another aspect of the above-described configuration, the video converting apparatus 401c according to the present example includes the decoder 421 decoding a coding stream of images, in addition to the configuration illustrated in FIG. 8 and the like, and is configured to input images decoded by the decoder 421 to the image buffer unit 403 included in the multiple-frame super-resolution processing unit 427. According to the above-described configuration, the video converting apparatus 401c intended to process coding streams can be realized.

In addition, the video converting apparatus 401c according to the present example is configured to further include a supplemental enhancement information for reference to at least one of the image buffer unit 403, the super-resolution processing unit 411, and the prediction image generation unit 405. The supplemental enhancement information decoder 425 decodes the supplemental enhancement information specifying the processing performed at the reference source, from the configuration illustrated in FIG. 8 and the like. According to the above-described configuration, the video converting apparatus 401c can be achieved that can decode coded supplemental enhancement information and reference the resultant information.

Note that, in another aspect of the present example, the decoder (decoding apparatus) 421 and the supplemental enhancement information decoder 425 are not provided in the video converting apparatus 401c, but may be realized as an external apparatus. Additionally, a single common memory may be used both as the reference picture memory 306 included in the decoder 421 and as the image buffer unit 403 included in the multiple-frame super-resolution processing unit 427.

### Configuration Example 5 of Video Converting Apparatus

A fifth configuration example of the video converting apparatus will be described. In the present example, a configuration will be described in which the video converting apparatus switches the processing on a decoded image in accordance with the supplemental enhancement information.

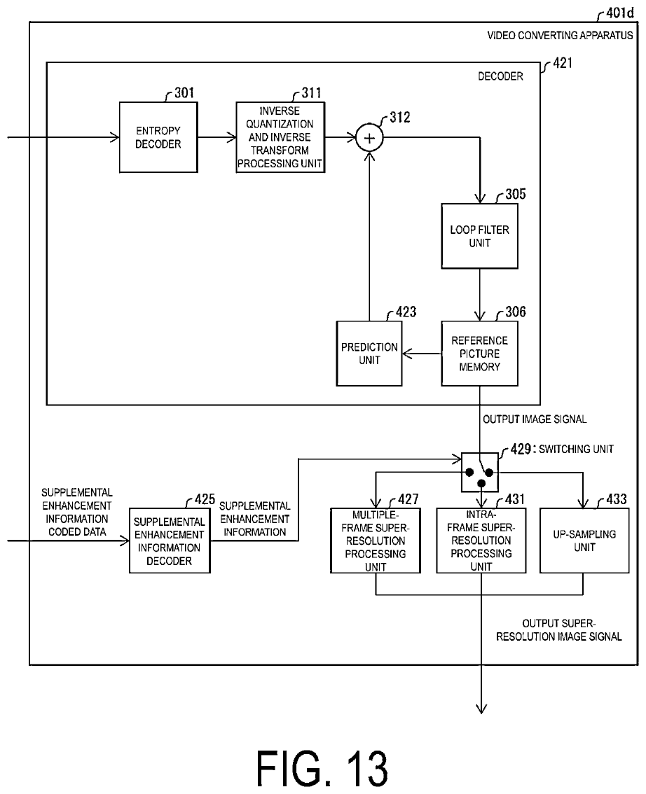

FIG. 13 is a functional block diagram of a video converting apparatus 401d according to the present example. As illustrated in FIG. 13, the video converting apparatus 401d according to the present example includes a switching unit 429, an intra-frame super-resolution processing unit 431, and an up-sampling unit 433, in addition to the configuration illustrated in FIG. 12.

The switching unit 429 references the supplemental enhancement information to switch the output destination of a decoded image output from the decoder 421 to any of the multiple-frame super-resolution processing unit 427, the intra-frame super-resolution processing unit 431, and the up-sampling unit 433. In other words, the supplemental enhancement information in the present example is information specifying the processing of the switching unit 429. The intra-frame super-resolution processing unit 431 references an image to be processed itself to perform super-resolution processing on the image. The up-sampling unit 433 up-samples the input image to output an image having a higher resolution than the input image on which the up-sampling has not been performed.

Note that switching can be performed in units of multiple accessible pictures referred to as a Group of Picture (GOP), on a per picture basis, or on a per block basis, the block being obtained by splitting a single picture.

In another aspect of the configuration described above, the video converting apparatus 401d according to the present example includes, for example, the decoder 421 decoding a coding stream of videos, the switching unit 429 switching among the output destinations of an image decoded by the decoder 421, the supplemental enhancement information decoder 425 decoding the supplemental enhancement information specifying the processing of the switching unit 429, and the like, in addition to the configuration illustrated in FIG. 12 and the like, and is configured such that the image buffer unit 403 included in the multiple-frame super-resolution processing unit 427 is one of the output destinations to which the decoded image is output and among which the switching unit 429 switches with reference to the supplemental enhancement information. According to the above-described configuration, the video converting apparatus 401d can be achieved that is intended to process a coding stream and that can output images subjected to super-resolution processing as necessary.

### Configuration of Video Coding Apparatus

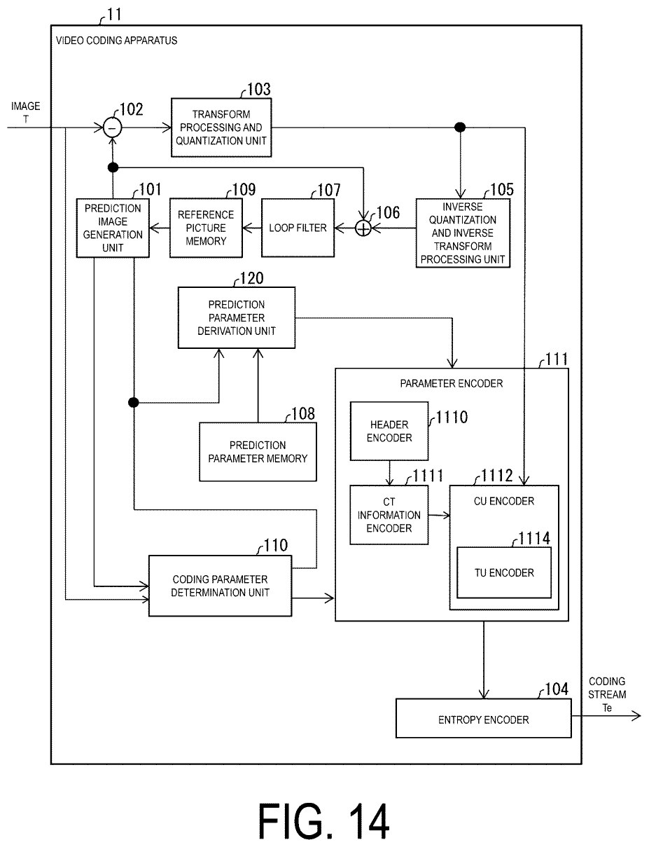

Now, a configuration of the video coding apparatus 11 according to the present embodiment will be described. FIG. 14 is a block diagram illustrating a configuration of the video coding apparatus 11 according to the present embodiment. The video coding apparatus 11 includes a prediction image generation unit 101, a subtraction unit 102, a transform processing and quantization unit 103, an inverse quantization and inverse transform processing unit 105, an addition unit 106, a loop filter 107, a prediction parameter memory (a prediction parameter storage unit and a frame memory) 108, a reference picture memory (a reference image storage unit and a frame memory) 109, a coding parameter determination unit 110, a parameter encoder 111, a prediction parameter derivation unit 120, and an entropy encoder 104.

The prediction image generation unit 101 generates a prediction image for each CU. The prediction image generation unit 101 includes the above-described inter prediction image generation unit 309 and the above-described intra prediction image generation unit 310, and description of the prediction image generation unit 101 is omitted.

The subtraction unit 102 subtracts the pixel value of a prediction image of a block input from the prediction image generation unit 101 from the pixel value of the image T to generate a prediction error. The subtraction unit 102 outputs the prediction error to the transform processing and quantization unit 103.

The transform processing and quantization unit 103 performs a frequency transform on the prediction error input from the subtraction unit 102 to calculate a transform coefficient, and performs quantization to derive a quantization transform coefficient. The transform processing and quantization unit 103 outputs the quantization transform coefficient to the parameter encoder 111 and the inverse quantization and inverse transform processing unit 105.

The inverse quantization and inverse transform processing unit 105 is the same as the inverse quantization and inverse transform processing unit 311 (FIG. 6) in the video decoding apparatus 31, and description of the inverse quantization and inverse transform processing unit 105 is omitted. The calculated prediction error is output to the addition unit 106.

The parameter encoder 111 includes a header encoder 1110, a CT information encoder 1111, and a CU encoder 1112 (prediction mode encoder). The CU encoder 1112 further includes a TU encoder 1114. General operation of each module will now be described.

The header encoder 1110 performs coding processing on parameters such as header information, split information, prediction information, and quantization transform coefficients.

The CT information encoder 1111 codes QT, MT (BT and TT) split information, and the like.

The CU encoder 1112 codes the CU information, the prediction information, the split information, and the like.

In a case that the TU includes a prediction error, the TU encoder 1114 codes the QP update information and quantization prediction error.

The CT information encoder 1111 and the CU encoder 1112 feed to the parameter encoder 111 with syntax elements such as inter prediction parameters (predMode, merge_flag, merge_idx, inter_pred_idc, refIdxLX, mvp_LX_idx, and mvdLX), intra prediction parameters (intra_luma_mpm_flag, intran_luma_mpm_idx, intra_luma_mpm_reminder, and intra_chroma_pred_mode), and quantization transform coefficients.

Quantization transform coefficients and coding parameters (split information and prediction parameters) are input to the entropy encoder 104 from the parameter encoder 111. The entropy encoder 104 performs entropy coding on the quantization coefficients and coding parameters to generate a coding stream Te, and outputs the coding stream Te.

The prediction parameter derivation unit 120 includes an inter prediction parameter encoder 112 and an intra prediction parameter encoder 113, and derives inter prediction parameters and intra prediction parameters from parameters input from the coding parameter determination unit 110. The derived inter prediction parameters and intra prediction parameter are output to the parameter encoder 111.

The addition unit 106 adds the pixel value of a prediction block input from the prediction image generation unit 101 to a prediction error input from the inverse quantization and inverse transform processing unit 105 for each pixel to generate a decoded image. The addition unit 106 stores the generated decoded image in the reference picture memory 109.

The loop filter 107 applies a deblocking filter, SAO, and ALF to the decoded image generated by the addition unit 106. Note that the loop filter 107 need not necessarily include the three types of filters described above, and may include only a deblocking filter, for example.

The prediction parameter memory 108 stores the prediction parameters generated by the coding parameter determination unit 110 for each picture and CU to be coded at a predetermined position.

The reference picture memory 109 stores the decoded image generated by the loop filter 107 for each picture and CU to be coded at a predetermined position.

The coding parameter determination unit 110 selects one set among multiple sets of coding parameters. The coding parameters refer to the QT, BT, or TT split information or prediction parameters described above, or parameters to be coded which are generated in association with the split information or the prediction parameters. The prediction image generation unit 101 uses the coding parameters to generate a prediction image.

The coding parameter determination unit 110 calculates, for each of the multiple sets, an RD cost value indicating the magnitude of the amount of information and a coding error. The RD cost value is, for example, the sum of a code amount and a value obtained by multiplying a square error by a coefficient λ. The code amount is an amount of information of the coding stream Te obtained by performing entropy coding on a quantization error and a coding parameter. The square error is the square sum of prediction errors calculated by the subtraction unit 102. The coefficient λ is a real number greater than a preconfigured zero. The coding parameter determination unit 110 selects a set of coding parameters of which cost value calculated is a minimum value. The coding parameter determination unit 110 outputs the determined coding parameters to the parameter encoder 111 and the prediction parameter derivation unit 120.

### Configuration Example 1 of Coded Data Generation Apparatus

A coded data generation apparatus according to the present embodiment will be described below. The coded data generation apparatus is an apparatus outputting a coding stream of images and supplemental enhancement information coded data. In the present example, the coded data generation apparatus 451c will be described that is paired with the video converting apparatus 401c or the like described above in the “Configuration Example 4 of Video Converting Apparatus”.

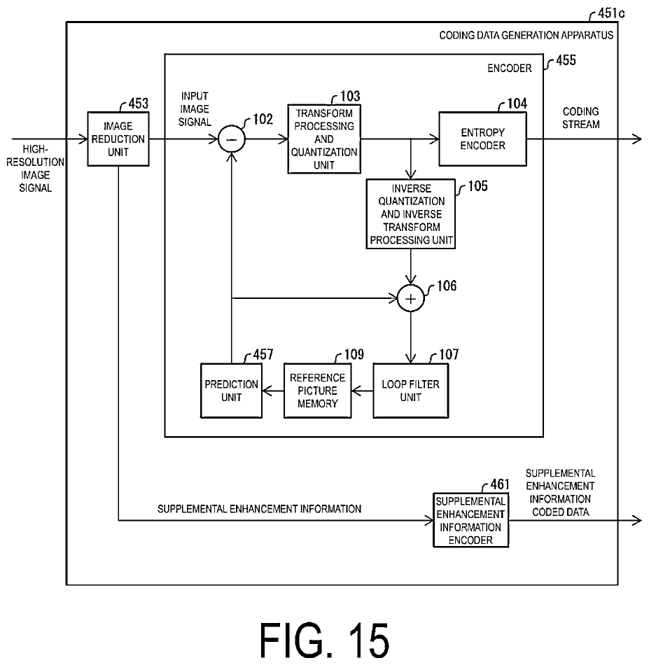

FIG. 15 is a functional block diagram illustrating the coded data generation apparatus 451c according to the present example. As illustrated in FIG. 15, the coded data generation apparatus 451c according to the present example includes an image reduction unit (down-sampling unit) 453, an encoder (coding apparatus) 455, and a supplemental enhancement information encoder 461.

The image reduction unit 453 down-samples an input image to output an image having a lower resolution than the input image on which the down-sampling has not been performed.

The encoder 455 is a coding apparatus having functions equivalent to the functions of the coding apparatus 11. However, in the example in FIG. 15, the configuration has been simplified.

The supplemental enhancement information encoder 461 codes supplemental enhancement information specifying the processing of the video converting apparatus. The supplemental enhancement information encoder 461 according to the present example codes, as supplemental enhancement information, information input from the image reduction unit 453 and indicating a reduction ratio for images. In another aspect, the image reduction unit 453 also functions as a supplemental enhancement information generation unit generating supplemental enhancement information indicating the reduction ratio for images. Note that the information may be referenced, for example, in a case that the super-resolution processing unit 411 included in the video converting apparatus 401c determines the resolution of a super-resolution image to be output.

The coded data generation apparatus 451c according to the present example includes a supplemental enhancement information generation unit (image reduction unit 453 in the example described above) generating supplemental enhancement information referenced by the video converting apparatus 401c (or 401, 401a, or 401b). The supplemental enhancement information may be supplemental enhancement information referenced by at least one of the image buffer unit 403, the super-resolution processing unit 411, and the prediction image generation unit 405. According to the above-described configuration, the coded data generation apparatus 451c paired with the video converting apparatus 401c and the like can be realized.

Note that the coded supplemental enhancement information may be included in a coding stream of images. In the configuration described above, for example, the entropy encoder 104 may be configured to synthesize the supplemental enhancement information coded data and the coding stream, or the entropy encoder 104 may be configured to function as the supplemental enhancement information encoder 461.

### Configuration Example 2 of Coded Data Generation Apparatus

A second configuration example of the coded data generation apparatus will be described. In the present example, a coded data generation apparatus 451d will be described that is paired with the video converting apparatus 401d described above in “Configuration Example 5 of Video Converting Apparatus”. Note that for convenience of description, duplicate description of the above-described matters is not repeated.

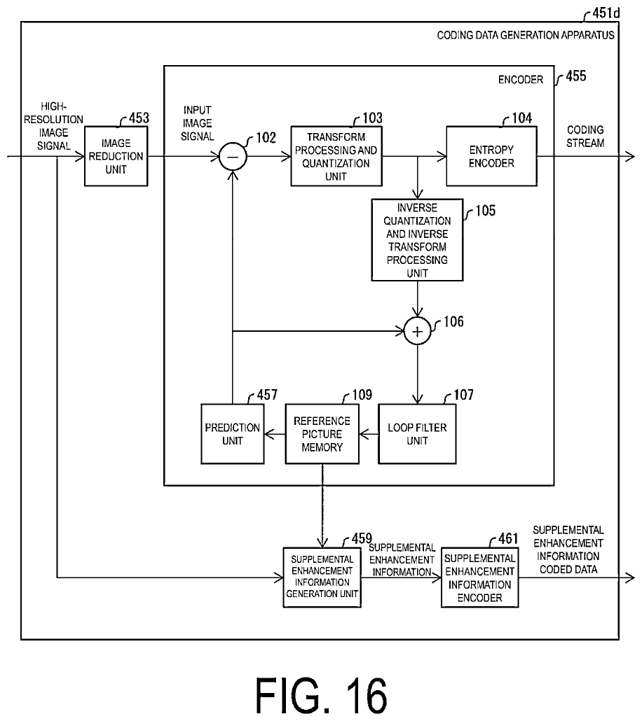

FIG. 16 is a functional block diagram illustrating a coded data generation apparatus 451d according to the present example. As illustrated in FIG. 16, the coded data generation apparatus 451d according to the present example includes the encoder (coding apparatus) 455, the image reduction unit 453, the supplemental enhancement information generation unit 459, and the supplemental enhancement information encoder 461.

The supplemental enhancement information generation unit 459 may generate supplemental enhancement information with reference to an image input to the coded data generation apparatus 451d and a decoded image stored in the reference picture memory 109. In the present example, the supplemental enhancement information may be information referenced in a case that the switching unit 429 of the video converting apparatus 401d switches the output destination of the decoded image. The supplemental enhancement information generated by the supplemental enhancement information generation unit 459 is input to the supplemental enhancement information encoder 461 and coded.

According to the above-described configuration, the coded data generation apparatus 451d paired with the video converting apparatus 401d can be realized.

### Configuration Example 3 of Coded Data Generation Apparatus

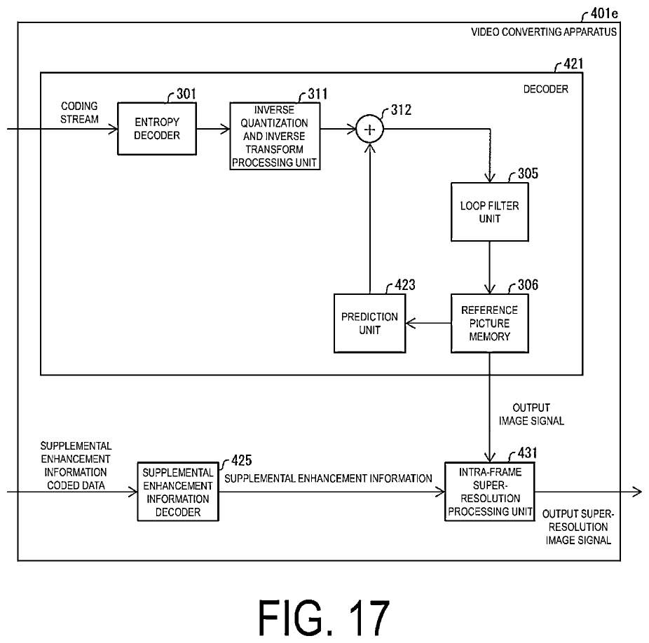

A third configuration example of the coded data generation apparatus will be described. In the present example, a coded data generation apparatus 451e will be described that is paired with the video converting apparatus 401c described above in “Configuration Example 4 of Video Converting Apparatus” or with the video converting apparatus 401e illustrated in FIG. 17. The video converting apparatus 401e includes the intra-frame super-resolution processing unit 431 instead of the multiple-frame super-resolution processing unit 427 in the video converting apparatus 401c. The intra-frame super-resolution processing unit 431 references an image to be processed itself to perform super-resolution processing on the image. Note that for convenience of description, duplicate description of the above-described matters is not repeated.

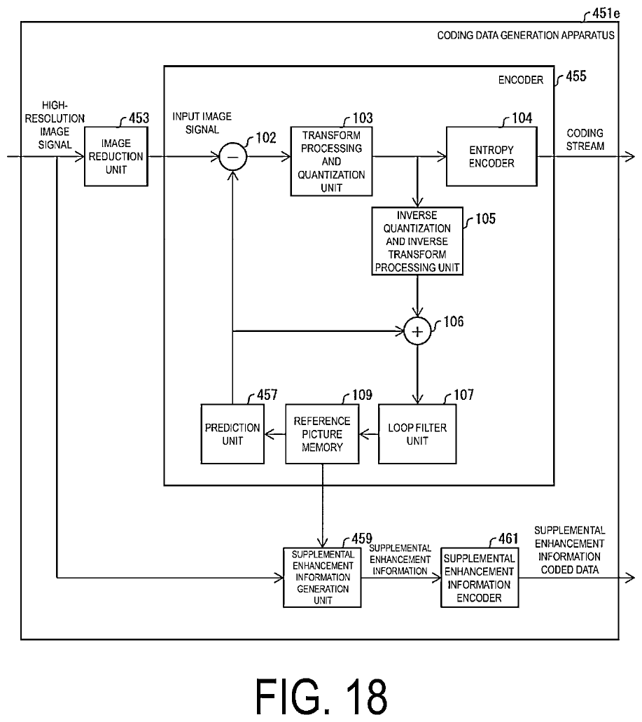

FIG. 18 is a functional block diagram illustrating the coded data generation apparatus 451e according to the present example. As illustrated in FIG. 18, the coded data generation apparatus 451e according to the present example includes the encoder (coding apparatus) 455, the image reduction unit 453, the supplemental enhancement information generation unit 459, and the supplemental enhancement information encoder 461.

With respect to a high-resolution image signal input to the coded data generation apparatus 451e, the supplemental enhancement information generation unit 459 generates supplemental enhancement information from complexity information based on frequency characteristics. The complexity information may be derived by image distribution or edge extraction. The supplemental enhancement information generation unit 459 may perform similar derivation of complexity information from the decoded image stored in the reference picture memory 109, and generate supplemental enhancement information through comparison with the complexity information. The supplemental enhancement information generation unit 459 may generate supplemental enhancement information on a per pixel basis, or may generate supplemental enhancement information on a per block basis in order to suppress the amount of information of the supplemental enhancement information. The supplemental enhancement information generation unit 459 may perform quantization processing in order to suppress the amount of information in the supplemental enhancement information. The supplemental enhancement information generated by the supplemental enhancement information generation unit 459 is input to the supplemental enhancement information encoder 461 and coded.

Note that a computer may be used to implement a part of each of the video coding apparatus 11 and the video decoding apparatus 31 in the above-described embodiments, for example, the entropy decoder 301, the parameter decoder 302, the loop filter 305, the prediction image generation unit 308, the inverse quantization and inverse transform processing unit 311, the addition unit 312, the prediction parameter derivation unit 320, the prediction image generation unit 101, the subtraction unit 102, the transform processing and quantization unit 103, the entropy encoder 104, the inverse quantization and inverse transform processing unit 105, the loop filter 107, the coding parameter determination unit 110, the parameter encoder 111, and the prediction parameter derivation unit 120. In that case, this configuration may be realized by recording a program for realizing such control functions on a computer-readable recording medium and causing a computer system to read the program recorded on the recording medium for execution. Note that the “computer system” as used herein refers to a computer system built into either the video coding apparatus 11 or the video decoding apparatus 31 and is assumed to include an OS and hardware components such as a peripheral apparatus. Furthermore, a “computer-readable recording medium” refers to a portable medium such as a flexible disk, a magneto-optical disk, a ROM, a CD-ROM, and the like, and a storage device such as a hard disk built into the computer system. Moreover, the “computer-readable recording medium” may include a medium that dynamically retains a program for a short period of time, such as a communication line in a case that the program is transmitted over a network such as the Internet or over a communication line such as a telephone line, and may also include a medium that retains the program for a fixed period of time, such as a volatile memory included in the computer system functioning as a server or a client in such a case. Furthermore, the above-described program may be one for realizing some of the above-described functions, and also may be one capable of realizing the above-described functions in combination with a program already recorded in a computer system.

A part or all of each of the video coding apparatus 11 and the video decoding apparatus 31 in the embodiments described above may be realized as an integrated circuit such as a Large Scale Integration (LSI). Each of the function blocks of the video coding apparatus 11 and the video decoding apparatus 31 may be individually realized as a processing unit, or some or all of the function blocks may be integrated into a processing unit. The circuit integration technique is not limited to LSI, and the integrated circuits for the functional blocks may be realized as dedicated circuits or a multi-purpose processor. In a case that with advances in semiconductor technology, a circuit integration technology with which an LSI is replaced appears, an integrated circuit based on the technology may be used.

The embodiment of the present disclosure has been described in detail above referring to the drawings, but the specific configuration is not limited to the above embodiments and various amendments can be made to a design that fall within the scope that does not depart from the gist of the present disclosure.

### Application Examples

The above-described video coding apparatus 11 and the video decoding apparatus 31 can be utilized being installed to various apparatuses performing transmission, reception, recording, and reconstruction of videos. Note that, the video may be a natural video imaged by camera or the like, or may be an artificial video (including CG and GUI) generated by computer or the like.

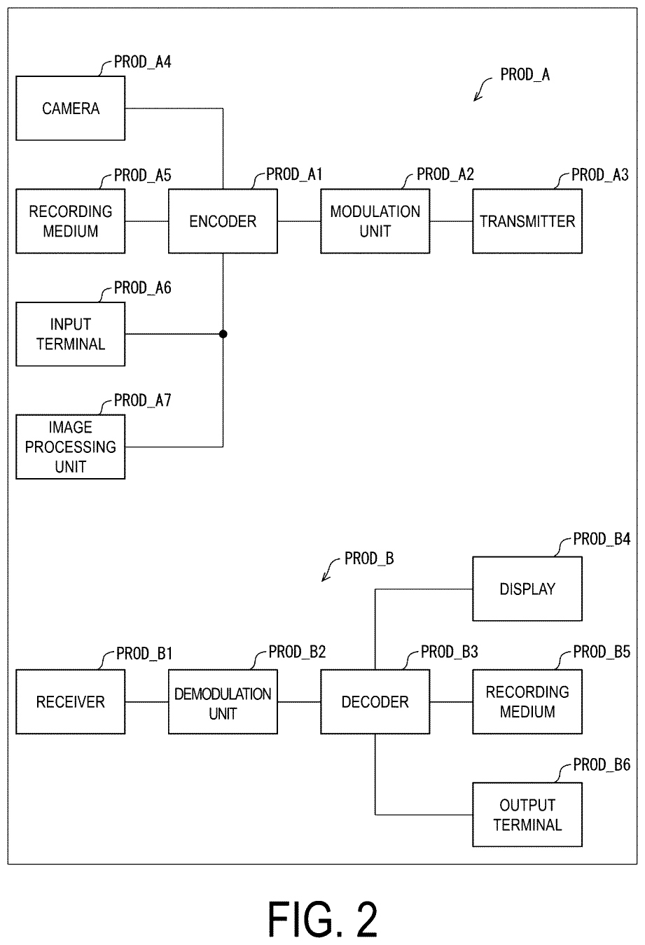

First, with reference to FIG. 2, the availability of the above-described video coding apparatus 11 and video decoding apparatus 31 for transmission and reception of videos will be described.

PROD A in FIG. 2 is a block diagram illustrating a configuration of a transmitting apparatus PROD_A equipped with the video coding apparatus 11. As illustrated in FIG. 2, the transmitting apparatus PROD_A includes an encoder PROD_A1 which obtains coded data by coding videos, a modulation unit PROD_A2 which obtains modulation signals by modulating carrier waves with the coded data obtained by the encoder PROD_A1, and a transmitter PROD_A3 which transmits the modulation signals obtained by the modulation unit PROD_A2. The above-described video coding apparatus 11 is utilized as the encoder PROD_A1.

The transmitting apparatus PROD_A may further include a camera PROD_A4 that images videos, a recording medium PROD_A5 that records videos, an input terminal PROD_A6 for inputting videos from the outside, and an image processing unit PROD_A7 which generates or processes images, as supply sources of videos to be input into the encoder PROD_A1. Although FIG. 2 illustrates a configuration in which the transmitting apparatus PROD_A includes all of the constituents, some of the constituents may be omitted.

Note that the recording medium PROD_A5 may record videos which are not coded or may record videos coded in a coding scheme for recording different from a coding scheme for transmission. In the latter case, a decoder (not illustrated) to decode coded data read from the recording medium PROD_A5 according to the coding scheme for recording may be present between the recording medium PROD_A5 and the encoder PROD_A1.

PROD_B in FIG. 2 is a block diagram illustrating a configuration of a receiving apparatus PROD_B equipped with the video decoding apparatus 31. As illustrated in FIG. 2, the receiving apparatus PROD_B includes a receiver PROD_B1 that receives modulation signals, a demodulation unit PROD_B2 that obtains coded data by demodulating the modulation signals received by the receiver PROD_B1, and a decoder PROD_B3 that obtains videos by decoding the coded data obtained by the demodulation unit PROD_B2. The above-described video decoding apparatus 31 is utilized as the decoder PROD_B3.

The receiving apparatus PROD_B may further include a display PROD_B4 that displays videos, a recording medium PROD_B5 for recording the videos, and an output terminal PROD_B6 for outputting the videos to the outside, as supply destinations of the videos to be output by the decoder PROD_B3. Although FIG. 2 illustrates a configuration that the receiving apparatus PROD_B includes all of the constituents, some of the constituents may be omitted.

Note that the recording medium PROD_B5 may record videos which are not coded, or may record videos which are coded in a coding scheme for recording different from a coding scheme for transmission. In the latter case, an encoder (not illustrated) that codes videos acquired from the decoder PROD_B3 according to the coding scheme for recording may be present between the decoder PROD_B3 and the recording medium PROD_B5.

Note that a transmission medium for transmitting the modulation signals may be a wireless medium or may be a wired medium. In addition, a transmission mode in which the modulation signals are transmitted may be a broadcast (here, which indicates a transmission mode in which a transmission destination is not specified in advance) or may be a communication (here, which indicates a transmission mode in which a transmission destination is specified in advance). That is, the transmission of the modulation signals may be realized by any of a wireless broadcast, a wired broadcast, a wireless communication, and a wired communication.

For example, a broadcasting station (e.g., broadcasting equipment)/receiving station (e.g., television receiver) for digital terrestrial broadcasting is an example of the transmitting apparatus PROD_A/receiving apparatus PROD_B for transmitting and/or receiving the modulation signals in the wireless broadcast. In addition, a broadcasting station (e.g., broadcasting equipment)/receiving station (e.g., television receivers) for cable television broadcasting is an example of the transmitting apparatus PROD_A/receiving apparatus PROD_B for transmitting and/or receiving the modulation signals in the wired broadcast.

In addition, a server (e.g., workstation)/client (e.g., television receiver, personal computer, smartphone) for Video On Demand (VOD) services, video hosting services and the like using the Internet is an example of the transmitting apparatus PROD_A/receiving apparatus PROD_B for transmitting and/or receiving the modulation signals in communication (usually, any of a wireless medium or a wired medium is used as a transmission medium in LAN, and the wired medium is used as a transmission medium in WAN). Here, personal computers include a desktop PC, a laptop PC, and a tablet PC. In addition, smartphones also include a multifunctional mobile telephone terminal.

A client of a video hosting service has a function of coding a video imaged with a camera and uploading the video to a server, in addition to a function of decoding coded data downloaded from a server and displaying on a display. Thus, the client of the video hosting service functions as both the transmitting apparatus PROD_A and the receiving apparatus PROD_B.

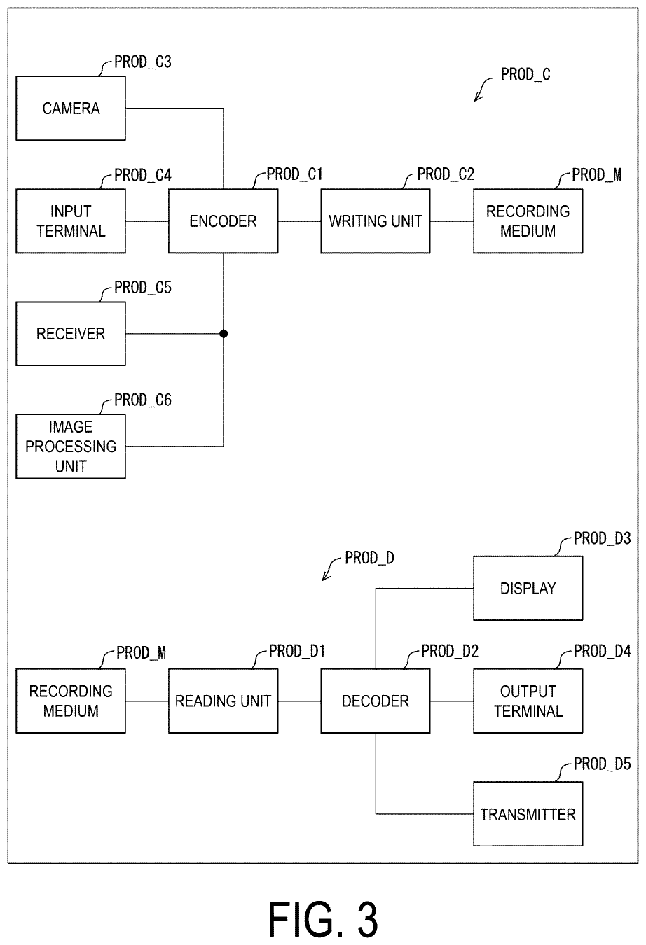

Now, with reference to FIG. 3, the availability of the above-described video coding apparatus 11 and video decoding apparatus 31 for recording and reconstruction of videos will be described.

PROD_C in FIG. 3 is a block diagram illustrating a configuration of a recording apparatus PROD_C equipped with the above-described video coding apparatus 11. As illustrated in FIG. 3, the recording apparatus PROD_C includes an encoder PROD_C1 that obtains coded data by coding a video, and a writing unit PROD_C2 that writes the coded data obtained by the encoder PROD_C1 in a recording medium PROD_M. The above-described video coding apparatus 11 is utilized as the encoder PROD_C1.

Note that the recording medium PROD_M may be (1) a type of recording medium built in the recording apparatus PROD_C such as Hard Disk Drive (HDD) or Solid State Drive (SSD), may be (2) a type of recording medium connected to the recording apparatus PROD_C such as an SD memory card or a Universal Serial Bus (USB) flash memory, and may be (3) a type of recording medium loaded in a drive apparatus (not illustrated) built in the recording apparatus PROD_C such as Digital Versatile Disc (DVD (trade name)) or Blu-ray Disc (BD (trade name)).

In addition, the recording apparatus PROD_C may further include a camera PROD_C3 that images a video, an input terminal PROD_C4 for inputting the video from the outside, a receiver PROD_C5 for receiving the video, and an image processing unit PROD_C6 that generates or processes images, as supply sources of the video input into the encoder PROD_C1. Although FIG. 3 illustrates a configuration in which the recording apparatus PROD_C includes all of the constituents, some of the constituents may be omitted.

Note that the receiver PROD_C5 may receive a video which is not coded, or may receive coded data coded in a coding scheme for transmission different from the coding scheme for recording. In the latter case, a decoder for transmission (not illustrated) that decodes coded data coded in the coding scheme for transmission may be present between the receiver PROD_C5 and the encoder PROD_C1.

Examples of such recording apparatus PROD_C include, for example, a DVD recorder, a BD recorder, a Hard Disk Drive (HDD) recorder, and the like (in this case, the input terminal PROD_C4 or the receiver PROD_C5 is the main supply source of videos). In addition, a camcorder (in this case, the camera PROD_C3 is the main supply source of videos), a personal computer (in this case, the receiver PROD_C5 or the image processing unit C6 is the main supply source of videos), a smartphone (in this case, the camera PROD_C3 or the receiver PROD_C5 is the main supply source of videos), or the like is an example of the recording apparatus PROD_C as well.

PROD_D in FIG. 3 is a block illustrating a configuration of a reconstruction apparatus PROD_D equipped with the above-described video decoding apparatus 31. As illustrated in FIG. 3, the reconstruction apparatus PROD_D includes a reading unit PROD_D1 which reads coded data written in the recording medium PROD_M, and a decoder PROD_D2 which obtains a video by decoding the coded data read by the reader PROD_D1. The above-described video decoding apparatus 31 is utilized as the decoder PROD_D2.

Note that the recording medium PROD_M may be (1) a type of recording medium built in the reconstruction apparatus PROD_D such as HDD or SSD, may be (2) a type of recording medium connected to the reconstruction apparatus PROD_D such as an SD memory card or a USB flash memory, and may be (3) a type of recording medium loaded in a drive apparatus (not illustrated) built in the reconstruction apparatus PROD_D such as a DVD or a BD.

In addition, the reconstruction apparatus PROD_D may further include a display PROD_D3 that displays a video, an output terminal PROD_D4 for outputting the video to the outside, and a transmitter PROD_D5 that transmits the video, as the supply destinations of the video to be output by the decoder PROD D2. Although FIG. 3 illustrates a configuration in which the reconstruction apparatus PROD_D includes all of the constituents, some of the constituents may be omitted.

Note that the transmitter PROD_D5 may transmit a video which is not coded or may transmit coded data coded in the coding scheme for transmission different from a coding scheme for recording. In the latter case, an encoder (not illustrated) that codes a video in the coding scheme for transmission may be present between the decoder PROD_D2 and the transmitter PROD_D5.

Examples of the reconstruction apparatus PROD_D include, for example, a DVD player, a BD player, an HDD player, and the like (in this case, the output terminal PROD_D4 to which a television receiver, and the like are connected is the main supply destination of videos). In addition, a television receiver (in this case, the display PROD_D3 is the main supply destination of videos), a digital signage (also referred to as an electronic signboard or an electronic bulletin board, and the like, and the display PROD_D3 or the transmitter PROD_D5 is the main supply destination of videos), a desktop PC (in this case, the output terminal PROD_D4 or the transmitter PROD_D5 is the main supply destination of videos), a laptop or tablet PC (in this case, the display PROD_D3 or the transmitter PROD_D5 is the main supply destination of videos), a smartphone (in this case, the display PROD_D3 or the transmitter PROD_D5 is the main supply destination of videos), or the like is an example of the reconstruction apparatus PROD_D.

### Realization by Hardware and Realization by Software

Each block of the above-described video decoding apparatus 31 and the video coding apparatus 11 may be realized as a hardware by a logical circuit formed on an integrated circuit (IC chip), or may be realized as a software using a Central Processing Unit (CPU).

In the latter case, each apparatus includes a CPU performing a command of a program to implement each function, a Read Only Memory (ROM) stored in the program, a Random Access Memory (RAM) developing the program, and a storage apparatus (recording medium) such as a memory storing the program and various data, and the like. In addition, an objective of the embodiments of the present disclosure can be achieved by supplying, to each of the apparatuses, the recording medium that records, in a computer readable form, program codes of a control program (executable program, intermediate code program, source program) of each of the apparatuses that is software for realizing the above-described functions and by reading and executing, by the computer (or a CPU or a MPU), the program codes recorded in the recording medium.

As the recording medium, for example, tapes including a magnetic tape, a cassette tape and the like, discs including a magnetic disc such as a floppy (trade name) disk/a hard disk and an optical disc such as a Compact Disc Read-Only Memory (CD-ROM)/Magneto-Optical disc (MO disc)/Mini Disc (MD)/Digital Versatile Disc (DVD (trade name))/CD Recordable (CD-R)/Blu-ray Disc (trade name), cards such as an IC card (including a memory card)/an optical card, semiconductor memories such as a mask ROM/Erasable Programmable Read-Only Memory (EPROM)/Electrically Erasable and Programmable Read-Only Memory (EEPROM: trade name)/a flash ROM, logical circuits such as a Programmable logic device (PLD) and a Field Programmable Gate Array (FPGA), or the like can be used.

In addition, each of the apparatuses is configured to be connectable to a communication network, and the program codes may be supplied through the communication network. The communication network is required to be capable of transmitting the program codes, but is not limited to a particular communication network. For example, the Internet, an intranet, an extranet, a Local Area Network (LAN), an Integrated Services Digital Network (ISDN), a Value-Added Network (VAN), a Community Antenna television/Cable Television (CATV) communication network, a Virtual Private Network, a telephone network, a mobile communication network, a satellite communication network, and the like are available. In addition, a transmission medium constituting this communication network is also required to be a medium which can transmit a program code, but is not limited to a particular configuration or type of transmission medium. For example, a wired transmission medium such as Institute of Electrical and Electronic Engineers (IEEE) 1394, a USB, a power line carrier, a cable TV line, a telephone line, an Asymmetric Digital Subscriber Line (ADSL) line, and a wireless transmission medium such as infrared ray of Infrared Data Association (IrDA) or a remote control, BlueTooth (trade name), IEEE 802.11 wireless communication, High Data Rate (HDR), Near Field Communication (NFC), Digital Living Network Alliance (DLNA: trade name), a cellular telephone network, a satellite channel, a terrestrial digital broadcast network are available. Note that the embodiments of the present disclosure can be also realized in the form of computer data signals embedded in a carrier such that the transmission of the program codes is embodied in electronic transmission.

The embodiments of the present disclosure are not limited to the above-described embodiments, and various modifications are possible within the scope of the claims. That is, an embodiment obtained by combining technical means modified appropriately within the scope defined by claims is included in the technical scope of the present disclosure as well.

### INDUSTRIAL APPLICABILITY

The embodiments of the present disclosure can be preferably applied to a video decoding apparatus that decodes coded data in which image data is coded, and a video coding apparatus that generates coded data in which image data is coded. The embodiments of the disclosure can be preferably applied to a data structure of coded data generated by the video coding apparatus and referenced by the video decoding apparatus.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1: A video converting apparatus comprising:
a supplemental enhancement information decoder circuit that decodes supplemental enhancement information including a parameter, which is a parameter for switching a resolution resampling process and an up-sampling process;
a resolution processing circuit that performs the resolution resampling process based on a value of the parameter; and
an up-sampling circuit that performs the up-sampling process based on the value of the parameter; wherein
if more than one supplemental enhancement information for a same picture is present, the more than one supplemental enhancement information has a same value of the parameter or different values of the parameter.

2: An image decoding apparatus comprising:
a supplemental enhancement information decoder circuit that decodes supplemental enhancement information including a parameter, which is a parameter for switching a resolution resampling process and an up-sampling process;
a resolution processing circuit that performs the resolution resampling process based on a value of the parameter; and
an up-sampling circuit that performs the up-sampling process based on the value of the parameter; wherein
if more than one supplemental enhancement information for a same picture is present, the more than one supplemental enhancement information has a same value of the parameter or different values of the parameter.

3: An image coding apparatus comprising:
a supplemental enhancement information coder circuit that codes supplemental enhancement information including a parameter, which is a parameter for switching a resolution resampling process and an up-sampling process;
a resolution processing circuit that performs the resolution resampling process based on a value of the parameter; and
an up-sampling circuit that performs the up-sampling process based on the value of the parameter; wherein
if more than one supplemental enhancement information for a same picture is present, the more than one supplemental enhancement information has a same value of the parameter or different values of the parameter.
